(19) United States
(12) Patent Application Publication
(10) Pub. No.: US 2011/0229202 A1
(43) Pub. Date: Sep. 22, 2011

(54) MEMBER FOR IMAGE FORMING DEVICE

(76) Inventors: Yoshihisa Mizumoto, Hyogo (JP); Mutsuki Sugimoto, Hyogo (JP)

(21) Appl. No.: 12/671,870

(22) PCT Filed: Jul. 16, 2008
(86) PCT No.: PCT/JP2008/062834

§ 371 Date: Feb. 2, 2010

(30) Foreign Application Priority Data
Aug. 3, 2007 (JP) 2007-203099

(51) Int. Cl. G03G 15/22

(52) U.S. Cl. 399/130

(57) ABSTRACT

Provided is a member for an image forming device. The member has a base material and a film on the surface of the base material. The film is formed to maintain the surface shape of the base material. The member is provided with the base material composed of rubber of a resin, and the metal film composed of a metal, metal oxide, metal carbide, metal nitride or metal sulfide. The metal film is a conductive film formed by ion-plating titanium, aluminum or the like.

### TECHNICAL FIELD

The present invention relates to members for image-forming apparatuses and more particularly to members that can be preferably used for image-forming apparatuses such as a copying machine, a facsimile, a printer, an automatic teller machine (ATM), and the like.

### BACKGROUND ART

Because various performances are demanded for the member for the image-forming apparatus and required to have incompatible properties, it is often the case with many members for the image-forming apparatus that the surfaces thereof are coated with a film and a double-layer construction is formed to cope with the demand and the necessity.

As described in U.S. Pat. No. 3,404,713 (patent document 1) or in Japanese Patent Application Laid-Open No. 2000-221774 (patent document 2), the film is formed on the surfaces of the members for the image-forming apparatus by metal plating, metal coating or resin coating.

Such a film has usually a thickness not less than 5 μm. More specifically, in the developing roller of the patent document 1, as described in claim 1, the thickness of the unmagnetic layer which is the film is 5 to 20 μm. In the developing roller of the patent document 2, as described in the example (column 84), the thickness of the surface layer which is the film is 12±1 μm.

The surface of the above-described member for the image-forming apparatus is microscopically a rough surface having fine irregularities and has a required characteristic configuration. Thereby it is possible to control the state of contact between the surface of the member for the image-forming apparatus and materials which do not usually contact the surface of the member. For example, enlargingly and sectionally showing the surface of the developing roller which is a member for the image-forming apparatus, the surface of the developing roller is as shown in diagrams of FIGS. 1 and 2.

When the thickness of a film 12 is not less than 5 μm, the film 12 is incapable of coating the surface of a substrate 11 along the surface configuration thereof, thus partly filling irregularities of the surface of the substrate 11. Thus the film 12 has a problem that the configuration of the substrate 11 cannot be controlled. As shown in FIG. 2, when the thickness of the film 12 is larger than that shown in FIG. 1, the film 12 entirely fills the irregularities of the substrate 11. Thus the nonuniform thickness of the film 12 and the absolute value of the thickness significantly change electrical or mechanical properties of the entire member for the image-forming apparatus. Consequently there arises a problem that the property of the member for the image-forming apparatus is influenced by the accuracy of the film.

Patent document 1: U.S. Pat. No. 3,404,713

Patent document 2: Japanese Patent Application Laid-Open No. 2000-221774

### DISCLOSURE OF THE INVENTION

### Problem to be Solved by the Invention

It is an object of the present invention to provide a member, for an image-forming apparatus, having a double construction composed of a substrate and a film which is capable of maintaining a surface configuration of the substrate and does not influence the surface configuration of the substrate, as requested for the member for the image-forming apparatus.

### Means for Solving the Problem

To solve the above-described problem, the present invention provides a member for an image-forming apparatus comprising a substrate consisting of a rubber or a resin and a metal film, formed on a surface of said substrate, which consists of a metal, a metal oxide, a metal carbide, a metal nitride or a metal sulfide.

As described above, the member of the present invention for an image-forming apparatus has a double construction composed of the substrate consisting of the rubber or the resin and the film formed on the surface of the substrate.

The substrate and the film may be composed of only one layer or not less than two layers having different compositions. A layered construction of one layer of the substrate and one layer of the film is preferable because such a layered construction can be produced simply and from the standpoint of production efficiency.

It is preferable that a rough surface or irregularities are formed on said surface of said substrate; and said metal film having a thickness not more than 1000 nm is formed on said surface of said substrate in a state in which a configuration of said surface of said substrate is maintained.

The reason the thickness of the metal film is set to not more than 1000 nm is because when the thickness thereof exceeds 1000 nm, as shown in FIG. 1, concavities are filled with the film. Thus the surface configuration of the substrate cannot be maintained and further there arise a problem that the nonuniform thickness of the film and the absolute value of the thickness significantly change the electrical or mechanical properties of the entire member for the image-forming apparatus.

The thickness of the metal film is 1 nm to 1 μm, favorably 5 nm to 990 nm, more favorably 5 to 490 nm, and most favorably 17 to 240 nm.

The reason the lower limit value of the thickness of the metal film is set to 1 nm is because when the thickness of the metal film is set to less than 1 nm, there is a possibility that the effect to be brought about by the formation of the film cannot be obtained.

A surface roughness Rz of said surface of said substrate is 1 μm to 10 μm, favorably 3 to 8 μm, and more favorably 5 to 8 μm.

A difference between surface roughness Rz of the film formed on the surface of the substrate to coat the surface thereof is set to favorably not more than 2 μm, more favorably not more than 1.5 μm, and most favorably not more than 1 μm, and especially favorably not more than 0.3 μm.

The surface roughness Rz means “10-point average roughness Rz” measured in accordance with JIS B 0601(1994).

When the difference between the surface roughness of the film is more than 2 μm which is the upper limit value, the accuracy at the time of the formation of the film influences the configuration of said surface of said substrate and electrical and mechanical properties thereof. The smaller is the difference, the better. The lower limit value is 0 μm.

Metals to be used as the metal film include one kind or a plurality of kinds of metals selected from among titanium, aluminum, nickel, copper, chromium, molybdenum, tungsten, zinc, tin, indium, iron, silver, gold, and magnesium and alloys of these metals. It is preferable that the metal film is a conductive film formed by ion-plating these metals, the metal oxide, the metal carbide, the metal nitride or the metal sulfide. Of these metals, metals whose adhesion strengths become higher in accordance with the substrate and have necessary conductivities are appropriately selected. Considering performance and cost, titanium, aluminum, zinc, and iron are preferably used.

The substrate consisting of the rubber or the resin is not limited to a specific one, but it is preferable that the substrate is conductive and has an electric resistance of 10³˜10¹⁰Ω.

To eliminate the possibility of discharge to other members which contact the member for the image-forming apparatus contacts, it is preferable that the electric resistance value of the substrate is set to not less more than 10³Ω. To prevent defective images from being formed owing to toner separation, it is preferable that the electric resistance value of the substrate is set to not more than 10¹⁰Ω. The electric resistance value of the substrate is favorably 10⁴Ω˜10⁹Ω, more favorably 10⁵Ω˜10⁸Ω, and most favorably 10⁵Ω˜10⁷Ω.

In members such as a charging roller, a charging blade, a developing roller, a transfer roller, and a transfer belt, for an image-forming apparatus, which are demanded to have conductivity, it is preferable to so select a material for the film that surface electric resistances (Ra) of the members for the image-forming apparatus after the film is formed on the surface of the substrate is lower than an electric resistance (Rb) of the substrate before the metal film is formed on the surface of the substrate. More specifically, the ratio of Rb/Ra is preferably 10⁵˜10²⁰.

As described above, although the conductive metal film has a very low electric resistance, the thickness thereof is as thin as not more than 1 μm. Therefore the member for the image-forming apparatus demanded to have conductivity is capable of obtaining a moderate conductivity.

It is preferable that the thickness of the conductive metal film having a low electric resistance is small, because the thin conductive metal film does not extremely reduce the electric resistance value of the member for the image-forming apparatus and thus it is easy to adjust the electric resistance value.

Because the above-described metal film has a very low electric resistance, an electric charge can be easily injected to other members that contact the metal film and toner.

That is, in the case of a developing roller consisting of the substrate not having the metal film formed on the surface of the substrate, when the electrostatic property of the toner is improved, toner separation becomes unfavorable and it is difficult to obtain a favorable print density. On the other hand, when the electric resistance value is lowered to improve the toner separation, there occurs a problem of a decrease in the electrostatic property of the toner. When the substrate consists of vulcanized rubber and particularly an ionic-conductive rubber, the above-described tendency is conspicuous.

On the other hand, by forming the metal film having a very low electric resistance on the surface of the substrate, it is easy to inject an electric charge into the toner and leak electricity (suppress drop of voltage) when the toner flies. Further because the metal film is thin and thus does not greatly lower the electric resistance value of the roller, it is possible to maintain the charged amount of the toner. Consequently it is possible to make incompatible performances compatible, i.e., it is possible to securely obtain a sufficient print density and restrain the generation of a defective image such as fogging which is caused by a drop in the charged amount of the toner.

To satisfy the above-described requirements, it is preferable to form the conductive metal film by the ion plating. The ion plating is especially preferable because the ion plating is fast in producing a film, industrially advantageous, and has a favorable adhesion.

The above-described method of forming the film is not limited to the ion plating, but known methods can be used. A vacuum evaporation method such as resistance heating evaporation, EB evaporation, cluster ion beam; a sputtering method such as RF sputtering, DC sputtering, magnetron sputtering, and ion beam sputtering; and a CVD method are exemplified.

It is possible to form the metal film by plating. In forming a plated film by forming the substrate into a necessary configuration and thereafter immersing the substrate in a plating liquid, it is not easy to control the thickness of the metal film in nanometers not more than 1 μm. Therefore the ion-plating is optimum.

As described above, the material of the substrate for the member of the image-forming apparatus is not limited to a specific one so long as the material consists of rubber or resin, but as the material of the substrate, crosslinked rubber represented by silicone rubber, urethane rubber, and diene rubber or resin; and thermoplastic resin or thermoplastic elastomer are listed. In view of adhesion and volatility, it is favorable that at least the outermost layer of the member is composed of the vulcanized rubber. It is more favorable that the entire substrate is composed of the vulcanized rubber.

The configuration of the substrate is not limited to a specific one either, but any configurations may be adopted. For example, the substrate may be roller-shaped, sheet-shaped, belt-shaped or blade-shaped.

The method of molding the substrate should be appropriately selected according to the kind of the material of the substrate. When the material of the substrate is resin, elastomer or rubber, it is possible to use known molding methods such as transfer molding, compression molding, extrusion molding or injection molding.

More specifically, when the substrate is roller-shaped, sheet-shaped or blade-shaped, it is preferable to mold the material of the substrate by the extrusion molding. When the substrate is belt-shaped, it is preferable to mold the material of the substrate by centrifugal molding or the extrusion molding. It is also preferable to mold the material of the substrate by carrying out a method of continuously supplying the material of the substrate to the outer surface of a cylindrical die with the die being rotated and at the same time, uniformly applying the material to the outer surface of the die with the nozzle being moved in the axial direction of the rotational shaft thereof, and thereafter hardening the material.

When the material of the substrate is the vulcanized rubber, after the material is molded, it is vulcanized. As a vulcanizing method, the material is vulcanized with a vulcanizing can, by using continuous vulcanization or pressure vulcanization by a press. It is also possible to perform surface treatment by abrasion or the like and execute post-treatment to obtain predetermined surface properties. It is very desirable to abrade the surface to obtain stability in dimensional accuracy and uniformity in the surface roughness. When abrasion treatment is performed, it is preferable to clean the surface of the substrate with a solvent, irradiate the surface thereof with ultraviolet rays or ozone, treat the surface thereof with chlorine or perform corona treatment, and thereafter perform coating treatment because these treatments are superior in allowing the treated film to have a high adhesion. These treatments are performed after the surface of the substrate is abraded when abrading treatment is carried out and after vulcanization is performed when the abrading treatment is not carried out.

The member of the present invention for the image-forming apparatus composed of the substrate on which the film is formed can be preferably used for the image-forming apparatus such as a copying machine, a facsimile, a printer, an automatic teller machine (ATM), and the like.

More specifically, members used in the image-forming apparatus for charging use, developing use, transferring use, toner supply use, cleaning use, toner layer restricting use, paper-feeding use, and preventing paper from being fed in layers are listed. More specifically, a charging roller, a charging blade, a developing roller, a transfer roller, a toner supply roller, and a toner layer restricting blade, a cleaning roller, a cleaning blade, a paper feeding roller (more specifically, a paper supply roller, a transport roller or a paper discharge roller, and the like constructing a paper supply mechanism), a separation pad, a separation sheet, a separation roller, and the like are listed.

As the member of the present invention for the image-forming apparatus, a member for charging a toner or other members and a member for transferring or transporting the toner are favorable and a member for charging the toner or an electrostatic latent image holding member represented by a photosensitive member is more favorable. The member of the present invention for the image-forming apparatus can be especially preferably used as the developing roller.

### Effect of the Invention

As described above, in the member of the present invention for the image-forming apparatus, the metal film having a thickness as thin as not more than 1000 nm is formed on the surface of said substrate. Therefore the metal film is formed along irregularities of the surface of said substrate and is thus capable of maintaining the surface configuration of the substrate. Further the nonuniform thickness of the metal film and the absolute value of the thickness do not significantly change the electrical or mechanical properties of the entire member for the image-forming apparatus. In addition, the characteristic of the member of the present invention for the image-forming apparatus can be displayed without being dependent on the accuracy of the film.

### BRIEF DESCRIPTION OF THE DRAWINGS

FIG. 1 is a diagram showing a microscopic state of a film in a conventional roller-shaped member for an image-forming apparatus.

FIG. 2 is a diagram showing a microscopic state of a thicker film in a conventional roller-shaped member for an image-forming apparatus.

FIG. 3 is a perspective view of a roller-shaped member for an image-forming apparatus according to one embodiment of the present invention.

FIG. 4 is a microscopic diagram of a section of the roller-shaped member for the image-forming apparatus shown in FIG. 3.

FIG. 5 is a schematic view showing a method of forming a metal film by arc ion plating using a shielding plate.

FIG. 6 shows a method of measuring an electric resistance of a roller in an example.

### EXPLANATION OF REFERENCE NUMERALS AND SYMBOLS

1: roller which is member for image-forming apparatus
2: core
11: substrate
12: metal film
40: shielding plate
50: target metal (evaporation source)
51: metal ion
52: metal droplet

### BEST MODE FOR CARRYING OUT THE INVENTION

A roller consisting of a developing roller for an image-forming apparatus is described below as an embodiment of the member of the present invention for the image-forming apparatus.

A rod-shaped core (shaft) 2 is fixed to a hollow portion of a roller 1. The core 2 is fixed to the roller 1 by press fit or may be bonded to the roller 1 with an adhesive agent or the like. The core 2 can be made of a metal such as aluminum, aluminum alloy, SUS or iron or ceramics.

The roller 1 is composed of a substrate 11 and a metal film 12 formed on the surface of the substrate 11. FIG. 4 is a diagram showing the roller 1 by enlarging a section thereof.

In this embodiment, the metal film 12 is made of an electrically conductive metal film formed by ion-plating titanium. The thickness of the metal film 12 is 5 nm to 990 nm.

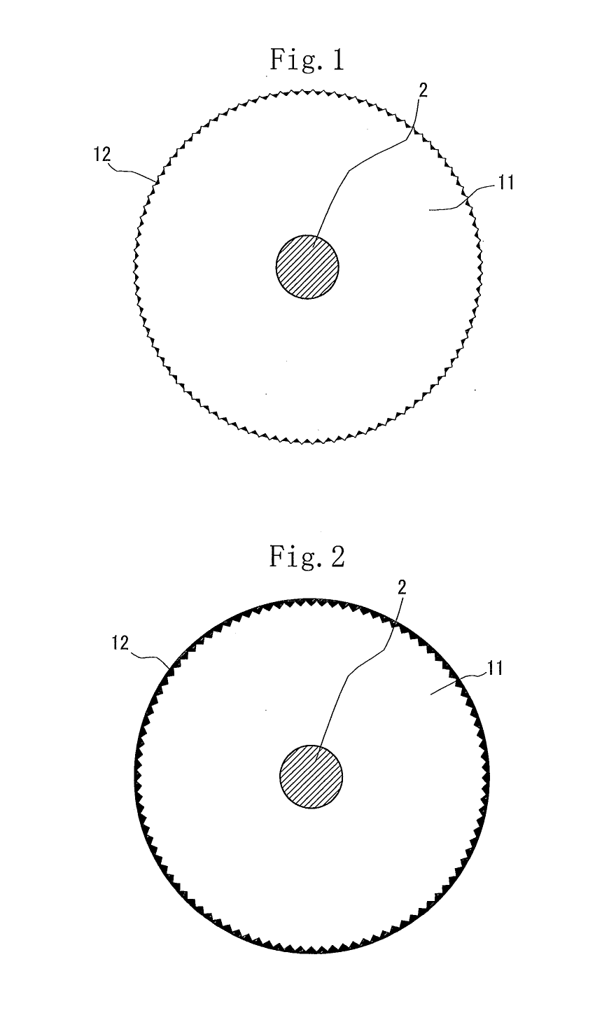

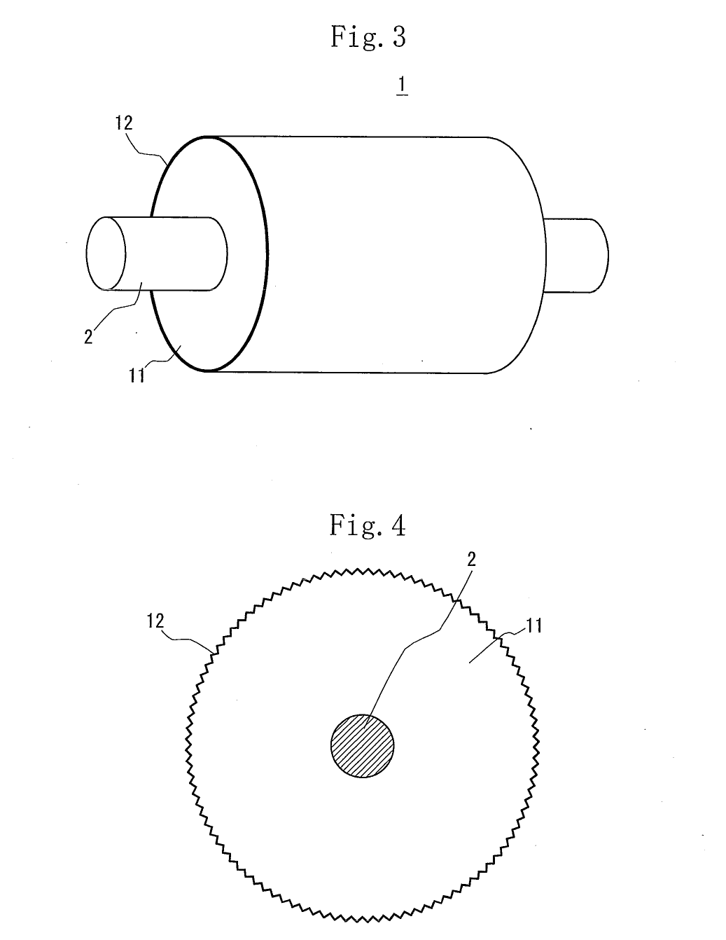

Because the metal film 12 is formed very thinly on the surface of the substrate 11 along irregularities of the surface thereof, the configuration of the surface of the substrate 11 can be maintained owing to the metal film 12, and as shown in FIGS. 1 and 2, is not changed by the metal film 12.

As an ion plating method, arc ion plating of forming a film between a substrate and a target metal by using a shielding plate at a deposition time. By using this method, unionized metal droplets which fly from the target metal attach to the shielding plate, while only metal ions fly over the shielding plate and attach to the surface of the substrate to form the metal film having a uniform thickness on the surface of the substrate 11.

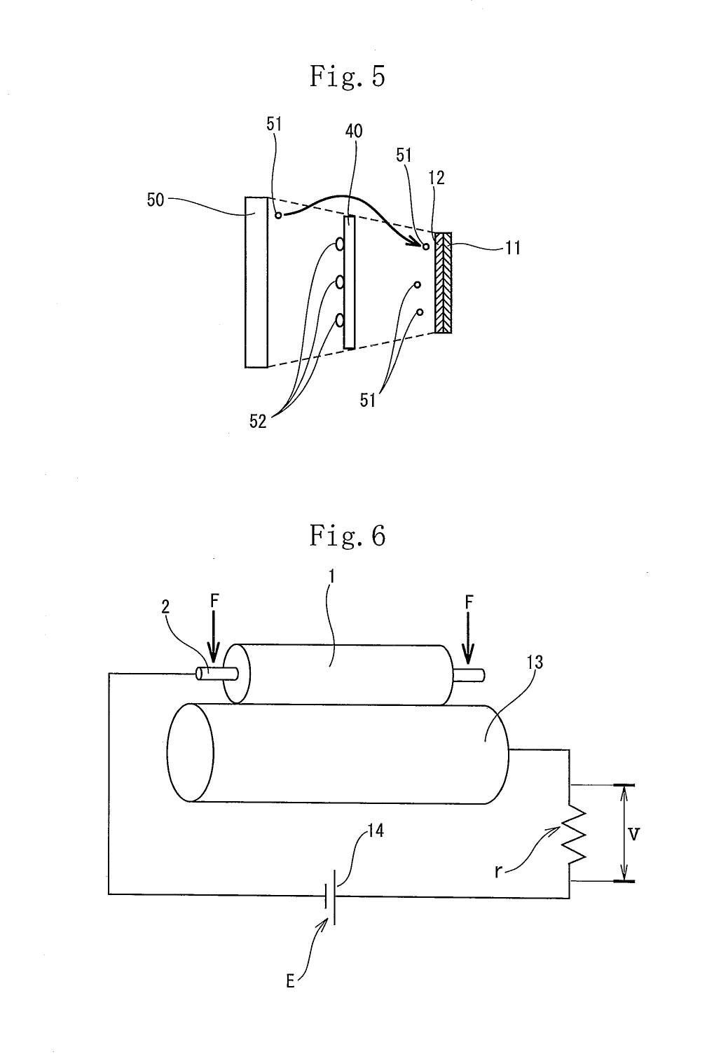

More specifically, as shown in FIG. 5, with a shielding plate 40 disposed between the substrate 11 and a target metal (solid evaporation source) 50, an energy is applied to the target metal (solid evaporation source) 50 so that metal ions 51 fly over the shielding plate 40 to form a film on the surface of the substrate 11. In this manner, the metal film 12 is formed. Thereby the thickness of the metal film 12 is controlled to be uniform by preventing the unionized metal droplets 52 from flying to the surface of the substrate 11 from the target metal 50.

The substrate 11 of the roller 1 is composed of vulcanized rubber. The composition of the vulcanized rubber is not limited to a specific one, but known rubber compositions may be used. It is preferable to use vulcanized rubber satisfying at least one of the requirements (1) or (2) described below.

(1) Vulcanized rubber which contains chlorine atoms and is ionic-conductive.

(2) Vulcanized rubber which contains an electronic conductive material and has an SP value not less than 18.0 (MPa)^{1/2}.

The vulcanized rubber which contains the chlorine atoms and is ionic-conductive is described below in detail.

As the rubber having the chlorine atoms, known rubber can be used, provided that it has the chlorine atoms. More specifically, unconductive rubber such as chloroprene rubber, chlorinated butyl, chlorosulfonated polyethylene, and the like little showing conductivity and conductive rubber such as an epichlorohydrin copolymer are listed.

It is preferable that the vulcanized rubber composing the substrate 11 has an ionic conductivity which provides a uniform electrical property.

When an ionic-conductive rubber is used as the rubber having the chlorine atoms, the vulcanized rubber is allowed to be ionic-conductive by adjusting the mixing amount of the ionic-conductive rubber. It is possible to use the ionic-conductive rubber or an ionic-conductive material not having the chlorine atoms in combination with the ionic-conductive rubber.

When an unconductive rubber is used as the rubber having the chlorine atoms, the unconductive rubber is combined with the ionic-conductive rubber or the ionic-conductive material is added to the unconductive rubber.

As the ionic-conductive rubber, copolymers containing ethylene oxide therein are exemplified. As the copolymers containing the ethylene oxide therein, polyether copolymers and epichlorohydrin copolymers are listed.

It is possible to select various ionic-conductive materials. It is possible to use those used as an antistatic agent or a charge control agent. As such ionic-conductive materials, it is possible to use quaternary ammonium salts, metal salts of carboxylic acid, carboxylic acid derivatives such as carboxylic acid anhydride, esters; condensates of aromatic compounds, organometallic complexes, metal salts, chelate compounds, monoazo metal complexes, acetylacetone metal complexes, hydroxycarboxylic acid metal complexes, polycarboxylic metal complexes, and polyol metal complexes.

As the ionic-conductive agents, anion-containing salts having a fluoro group (F—) and a sulfonyl group (—SO₂ —) are listed as preferable examples.

More specifically, salts of bisfluoroalkylsulfonylimide, salts of tris(fluoroalkylsulfonyl)methane, and salts of fluoroalkylsulfonic acid. As cations of the above-described salts making a pair with anions, metal ions of the alkali metals, the group 2A metals, and other metal ions are favorable. A lithium ion is more favorable.

As the ionic-conductive materials, LiCF₃SO₃, LiC₄F₉SO₃, LiN(SO₂CF₃)₂, LiC(SO₂CF₃)₃, and LiCH(SO₂CF₃)₂ are listed.

The mixing amount of the ionic-conductive material can be appropriately selected according to the kind thereof. For example, the mixing amount thereof for 100 parts by mass of the rubber component is set to favorably 0.1 to 5 parts by mass.

The vulcanized rubber composing the substrate 11 may contain rubber other than the rubber containing the chlorine atoms therein. As the “other rubbers”, acrylonitrile butadiene rubber (hereinafter referred to as “NBR”), acrylonitrile rubber, butadiene rubber, styrene butadiene rubber, urethane rubber, butyl rubber, fluororubber, isoprene rubber, silicone rubber, and the like are listed. It is also possible to exemplify low-resistant polymers such as bi-copolymers of propylene oxide and allyl glycidyl ether, glycidyl methacrylate, glycidyl acrylate, and an unsaturated epoxide such as butadiene monoxide. These rubbers can be used singly or in combination of two or more kinds thereof.

The mixing amount of the “other rubbers” is adjusted in a range in which the mixing amount thereof is uncontradictory to the object of the present invention. More specifically the mixing amount of the other rubbers is favorably not more than 20 mass % and more favorably not more than 10 mass % in the entire rubber component.

The vulcanized rubber which contains the electronic conductive material and has an SP value not less than 18.0 (MPa)^{1/2} is described below in detail.

As the ionic-conductive material, conductive carbon black such as Ketjen black, furnace black, and acetylene black; conductive metal oxides such as zinc oxide, potassium titanate, antimony-doped titanium oxide, tin oxide, and graphite; and carbon fibers. Of these ionic-conductive material, it is preferable to use the conductive carbon black. The mixing amount of the electroconductive material can be appropriately selected in consideration of the properties thereof such as the electric resistance value thereof. The mixing amount of the electroconductive material for 100 parts by mass of the rubber component is set to favorably 5 to 40 parts by mass and more favorably 10 to 25 parts by mass.

As the vulcanized rubber, unconductive rubber little showing conductivity and the ionic-conductive rubber can be used, provided that the SP value thereof is not less than 18.0 (MPa)^{1/2}.

In blending two or more kinds of rubbers with each other, rubber having the SP value less than 18.0 (MPa)^{1/2} may be used, but the mixing amount thereof is so adjusted that an apparent SP value thereof is not less than 18.0 (MPa)^{1/2}. The apparent SP value is obtained by computing the product of an SP value inherent in each rubber component and a mass mixing ratio of each rubber component when the entire rubber component is supposed to be one and by finding the sum of the products. For example, supposing that the SP value of a component a is Xa, that the mass mixing ratio thereof is Ya when the entire rubber component is supposed to be one, that the SP value of a component b is Xb, and that the mass mixing ratio thereof is Yb when the entire rubber component is supposed to be one, the apparent SP value is Xa·Ya+Xb·Yb.

The SP value means a solubility parameter or a solubility constant. For example, as is defined in a book “Flow of paint and dispersion of pigment” (compiled by Kenji Ueki and published by Kyoritsu Publishing Co., Ltd.), the SP value is the square root of a cohesive energy density of each liquid and serves as an index characterizing the solubility. The higher the SP value is, the higher the polarity is. As the rubber having the SP value not less than 18.0 (MPa)^{1/2}, epichlorohydrin copolymers, polyether copolymers, acrylic rubber, NBR rubber having an acrylonitrile content not less than 20%, and chloroprene rubber are listed.

As more favorable forms of the vulcanized rubber composing the substrate 11,

(a) Epichlorohydrin copolymer

(b) Combination of the chloroprene rubber, the epichlorohydrin copolymer or/and the polyether copolymer

(c) Combination of the chloroprene rubber, the NBR, the epichlorohydrin copolymer or/and the polyether copolymer

(d) Combination of the chloroprene rubber and the NBR

Above all, the combination (b-1) of the chloroprene rubber and the epichlorohydrin copolymer and the combination (b-2) of the chloroprene rubber, the epichlorohydrin copolymer, and the polyether copolymer are especially favorable.

In combining not less than two kinds of rubbers as the rubber composing the substrate 11, the mixing ratio thereof should be appropriately selected.

For example, (b-1) in the combination of the chloroprene rubber and the epichlorohydrin copolymer, supposing that the total mass of the rubber component is 100 parts by mass, it is preferable that the content of the epichlorohydrin copolymer is set to 5 to 95 parts by mass, favorably 20 to 80 parts by mass, and more favorably 20 to 50 parts by mass and that the content of the chloroprene rubber is set to 5 to 95 parts by mass, favorably 20 to 80 parts by mass, and more favorably 50 to 80 parts by mass.

(b-2) in the combination of the chloroprene rubber, supposing that the total mass of the rubber component is 100 parts by mass, it is preferable that the content of the epichlorohydrin copolymer is set to 5 to 90 parts by mass and favorably 10 to 70 parts by mass, that the content of the polyether copolymer is set to 5 to 40 parts by mass and favorably 5 to 20 parts by mass, and that the content of the chloroprene rubber is set to 5 to 90 parts by mass and favorably 10 to 80 parts by mass. By setting the mixing ratio among the three components to the above-described range, it is possible to favorably disperse the three components and improve the properties such as the strength of the rubber component. The mass ratio among the epichlorohydrin copolymer, the chloroprene rubber, and the polyether copolymer is set to favorably 2 to 5:4 to 7:0.5 to 1.5. The mass ratio among the epichlorohydrin copolymer, the chloroprene rubber, and the polyether copolymer is set to more favorably 2 to 5:4 to 7:1.

As the epichlorohydrin copolymers, epichlorohydrin homopolymer, an epichlorohydrin-ethylene oxide copolymer, an epichlorohydrin-propylene oxide copolymer, an epichlorohydrin-allyl glycidyl ether copolymer, an epichlorohydrin-ethylene oxide-allyl glycidyl ether copolymer, an epichlorohydrin-propylene oxide-allyl glycidyl ether copolymer, and an epichlorohydrin-ethylene oxide-propylene oxide-allyl glycidyl ether copolymer are listed.

It is preferable that the epichlorohydrin copolymer contains the ethylene oxide. The epichlorohydrin copolymer containing the ethylene oxide at not less than 30 mol % nor more than 95 mol %, favorably not less than 55 mol % nor more than 95 mol %, and more favorably not less than 60 mol % nor more than 80 mol % is especially preferable. The ethylene oxide has a function of decreasing the volume resistivity value of the epichlorohydrin copolymer, but when the content of the ethylene oxide is less than 30 mol %, the ethylene oxide has a low effect of decreasing the volume resistivity value thereof. On the other hand, when the content of the ethylene oxide is more than 95 mol %, the ethylene oxide crystallizes and the segment motion of the molecular chain thereof is prevented from taking place. Consequently the volume resistivity value of the epichlorohydrin copolymer tends to rise and in addition problems that the hardness of the vulcanized rubber rises and the viscosity of the rubber before vulcanization rises are liable to occur.

As the epichlorohydrin copolymer, it is especially preferable to use an epichlorohydrin (EP)-ethylene oxide (EO)-allyl glycidyl ether (AGE) copolymer. As the content ratio among the EO, the EP, and the AGE in the epichlorohydrin copolymer, EO:EP:AGE is set to favorably 30 to 95 mol %:4.5 to 65 mol %:0.5 to 10 mol % and more favorably 60 to 80 mol %:15 to 40 mol %:2 to 6 mol %.

As the epichlorohydrin copolymer, it is also possible to use an epichlorohydrin (EP)-ethylene oxide (EO) copolymer. As a favorable content ratio between the EO and the EP, EO:EP is 30 to 80 mol %:20 to 70 mol %. As a more favorable content ratio therebetween, EO:EP is 50 to 80 mol %:20 to 50 mol %.

When the epichlorohydrin copolymer is used for the vulcanized rubber, the mixing amount thereof for the total mass of 100 parts by mass of the rubber component is favorably not less than five parts by mass, more favorably not less than 15 parts by mass, and most favorably not less than 20 parts by mass.

As the polyether copolymer, an ethylene oxide-propylene oxide-allyl glycidyl ether copolymer, an ethylene oxide-allyl glycidyl ether copolymer, a propylene oxide-allyl glycidyl ether copolymer, an ethylene oxide-propylene oxide copolymer, and a urethane rubber.

It is favorable that the polyether copolymer contains the ethylene oxide. It is more favorable that the polyether copolymer contains 50 to 95 mol % of the ethylene oxide. As the mixing ratio of the ethylene oxide increases, it is possible to increasingly stabilize many ions and make the electric resistance low. But when the mixing ratio of the ethylene oxide is increased too high, the ethylene oxide crystallizes and the segment motion of the molecular chain thereof is prevented from taking place. Consequently there is a possibility that the electric resistance value rises.

It is preferable that the polyether copolymer contains the allyl glycidyl ether in addition to the ethylene oxide. By copolymerizing the allyl glycidyl ether, the allyl glycidyl ether unit obtains a free volume as a side chain. Thus the crystallization of the ethylene oxide is suppressed. As a result, an electric resistance lower than that conventionally obtained can be achieved. By the copolymerization of the allyl glycidyl ether, carbon-to-carbon double bonds are introduced into the polyether copolymer. Thus it is possible to crosslink it with other kind of rubber and thereby prevent occurrence of bleeding and contamination of other members such as a photosensitive member.

As the content of the allyl glycidyl ether in the polyether copolymer is preferably 1 to 10 mol %. At less than one mol %, bleeding and contamination of the other members are liable to occur. On the other hand, at more than 10 mol %, it is impossible to obtain the crystallization suppression effect to a higher extent than the extent of the crystallization suppression effect when the polyether copolymer contains 1 to 10 mol % of the allyl glycidyl ether, and the number of crosslinked points increases after vulcanization. Thus a low electric resistance cannot be achieved. In addition, the tensile strength, fatigue characteristic, and flexing resistance deteriorate.

As the polyether copolymer to be used in the present invention, it is preferable to use an ethylene oxide (EO)-propylene oxide (PO)-allyl glycidyl ether (AGE) terpolymer. By copolymerizing the propylene oxide, it is possible to suppress the crystallization of the ethylene oxide to a higher extent. As a preferable content ratio among the ethylene oxide (EO), the propylene oxide (PO), and the allyl glycidyl ether (AGE) of the polyether copolymer, EO:PO:AGE=50 to 95 mol %:1 to 49 mol %:1 to 10 mol %. To effectively prevent bleeding from occurring and the other members from being contaminated, it is preferable that the number-average molecular weight Mn of the EO-PO-AGE terpolymer is not less than 10,000.

When the polyether copolymer is used for the vulcanized rubber, the mixing amount thereof for the total mass of 100 parts by mass of the rubber component is favorably not less than five parts by mass and more favorably not less than 10 parts by mass.

The chloroprene rubber is a polymer of chloroprene and produced by emulsion polymerization thereof. In dependence on the kind of a molecular weight modifier, the chloroprene rubber is classified into a sulfur-modified type and a non-sulfur-modified type.

The chloroprene rubber of the sulfur-modified type is formed by plasticizing a polymer resulting from polymerization of sulfur and the chloroprene with thiuram disulfide or the like and adjusting the resulting chloroprene rubber to a predetermined Mooney viscosity. As the chloroprene rubber of the non-sulfur-modified type, a mercaptan-modified type and a xanthogen-modified type are listed. In the case of the mercaptan-modified type, alkyl mercaptans such as n-dodecyl mercaptan, tert-dodecyl mercaptan or octyl mercaptan is used as a molecular weight modifier. In the case of the xanthogen-modified type, an alkyl xanthogen compound is used as a molecular weight modifier.

In dependence on a crystallization speed of generated chloroprene rubber, the chloroprene rubber is classified into an intermediate crystallization speed type, a low crystallization speed type, and a high crystallization speed type.

The chloroprene rubber of both the sulfur-modified type and the non-sulfur-modified type can be used in the present invention. But it is preferable to use the non-sulfur-modified chloroprene rubber of the low crystallization speed type.

In the present invention, as the chloroprene rubber, it is possible to use rubber or elastomer having a structure similar to that of the chloroprene rubber. For example, it is possible to use a copolymer obtained by polymerizing a mixture of the chloroprene and not less than one kind of copolymerizable monomer. As monomers copolymerizable with the chloroprene, 2,3-dichloro-1,3-butadiene, 1-chloro-1,3-butadiene, sulfur, styrene, acrylonitrile, methacrylonitrile, isoprene, butadiene, acrylic acid, methacrylic acid, and esters thereof are listed.

When the chloroprene rubber is used for the vulcanized rubber, the mixing amount of the chloroprene rubber for the total mass of 100 parts by mass of the rubber component is selected at not less than 1 part by mass and less than 100 parts by mass. In view of the electrostatic property-imparting effect, the mixing amount of the chloroprene rubber is set to favorably not less than five parts by mass for 100 parts by mass of the rubber component. From the standpoint of making the rubber uniform, the mixing amount of the chloroprene rubber is set to more favorably not less than 10 parts by mass for 100 parts by mass of the rubber component. The mixing amount of the chloroprene rubber is set to favorably not more than 80 parts by mass and more favorably not more than 60 parts by mass for 100 parts by mass of the rubber component.

As the NBR, it is possible to use any of low-nitrile NBR whose acrylonitrile content is not more than 25%, intermediate-nitrile NBR whose acrylonitrile content is 25 to 31%, moderate high-nitrile NBR whose acrylonitrile content is 31 to 36%, and high-nitrile NBR whose acrylonitrile content is not less than 36%.

In the present invention, to decrease the specific gravity of the rubber, it is preferable to use the low-nitrile NBR having a small specific gravity. In view of the performance of mixing the NBR and the chloroprene rubber with each other, it is preferable to use the intermediate-nitrile NBR or the low-nitrile NBR. More specifically, from the standpoint of the solubility parameter, it is preferable to use the NBR whose acrylonitrile content is 15 to 39%, the NBR whose acrylonitrile content is favorably 17 to 35%, and the NBR whose acrylonitrile content is more favorably 20 to 30%.

When the NBR is used for the vulcanized rubber, the mixing amount of the NBR for the total mass of 100 parts by mass of the rubber component is set to favorably 5 to 65 parts by mass, more favorably 10 to 65 parts by mass, and most favorably 20 to 50 parts by mass. When the positively charged toner is used, the charged amount of the toner decreases. Thus the mixing amount of the NBR for 100 parts by mass of the rubber component is set to preferably not more than 65 parts by mass. To restrain a rise in the hardness and substantially obtain the effect of decreasing dependence on temperature, it is preferable that the content of the NBR for 100 parts by mass of the rubber component is set to not less than five parts by mass.

Components, other than the rubber component, contained in the vulcanized rubber composing the substrate 11 are described below.

The vulcanized rubber composing the substrate 11 contains a vulcanizing agent for vulcanizing the rubber component.

As the vulcanizing agent, it is possible to use sulfur-based and thiourea-based vulcanizing agents, triazine derivatives, peroxides, and monomers. These vulcanizing agents can be used singly or in combination of two or more kinds thereof. As the sulfur-based vulcanizing agent, powdery sulfur, organic sulfur-containing compounds such as tetramethylthiuram disulfide, N,N-dithiobismorpholine, and the like are listed. As the thiourea-based vulcanizing agent, tetramethylthiourea, trimethylthiourea, ethylenethiourea, and thioureas shown by (CₙH₂ₙ₊₁NH)₂C═S (in the formula, n indicates integers 1 to 10) are listed. As the peroxides, benzoyl peroxide is exemplified.

The mixing amount of the vulcanizing agent for 100 parts by mass of the rubber component is set to not less than 0.2 parts by mass nor more than five parts by mass and favorably not less than one nor more than three parts by mass.

In the present invention, it is preferable to use sulfur and thioureas in combination as the vulcanizing agent.

The mixing amount of the sulfur for 100 parts by mass of the rubber component is set to not less than 0.1 parts by mass nor more than 5.0 parts by mass and favorably not less than 0.2 parts by mass nor more than 2 parts by mass. The reason the above-described range is set is because when the mixing amount of the sulfur for 100 parts by mass of the rubber component is less than 0.1 parts by mass, the vulcanizing speed of the entire rubber composition is low and thus the productivity is unfavorable. On the other hand, when the mixing amount of the sulfur for 100 parts by mass of the rubber component is more than 5.0 parts by mass, there is a possibility that the compression set is high and the sulfur and an accelerating agent bloom.

The mixing amount of the thioureas for 100 g of the rubber component is set to not less than 0.0001 mol nor more than 0.0800 mol, favorably not less than 0.0009 mol nor more than 0.0800 mol, and more favorably not less than 0.0015 mol nor more than 0.0400 mol. By mixing the thioureas with the rubber component in the above-described mixing range, blooming and the contamination of the other members hardly occur, and further a molecular motion of the rubber is little interfered. Thus a low electric resistance can be achieved. As the crosslinking density becomes higher by increasing the addition amount of the thioureas, the electric resistance value can be lowered. That is, when the mixing amount of the thioureas for 100 g of the rubber component is less than 0.0001 mol, it is difficult to improve the compression set. To effectively lower the electric resistance value, it is preferable that the mixing amount of the thioureas for 100 g of the rubber component is not less than 0.0009 mol. On the other hand, when the mixing amount of the thioureas for 100 g of the rubber component is more than 0.0800 mol, the thioureas bloom from the surface of the rubber composition, thus contaminating the other components such as the photosensitive drum and extremely deteriorating the mechanical properties such as the breaking extension and the like.

In dependence on the kind of the vulcanizing agent, a vulcanizing accelerating agent or a vulcanizing accelerating assistant may be added to the rubber component.

As the vulcanizing accelerating agent, it is possible to use inorganic accelerating agents such as slaked lime, magnesia (MgO), and litharge (PbO); and organic accelerating agents shown below. As the organic accelerating agent, guanidines such as di-ortho-tolylguanidine, 1,3-diphenyl guanidine, 1-ortho-tolylbiguanide, di-ortho-tolylguanidine salts of dicatechol borate; thiazoles such as 2-melcapto-benzothiazole, dibenzothiazolyl disulfide; sulfinamides such as N-cyclohexyl-2-benzothiazolylsulfinamide; thiurams such as tetramethylthiuram monosulfide, tetramethylthiuram disulfide, tetraethylthiuram disulfide, and dipentamethylenethiuram tetrasulfide; and thioureas. It is possible to use the above-described organic accelerating agents singly or by combining these organic accelerating agents with each other.

The mixing amount of the vulcanizing accelerating agent for 100 parts by mass of the rubber component is set to favorably not less than 0.5 nor more than five parts by mass and more favorably not less than 0.5 nor more than two parts by mass.

As the vulcanizing accelerating assistants, metal oxides such as zinc white; fatty acids such as stearic acid, oleic acid, cotton seed fatty acid, and the like; and known vulcanizing accelerating assistants are listed.

The addition amount of the vulcanizing accelerating assistant for 100 parts by mass of the rubber component is set to favorably not less than 0.5 parts by mass nor more than 10 parts by mass and more favorably not less than two parts by mass nor more than eight parts by mass.

When the vulcanized rubber composing the substrate 11 contains the rubber containing the chlorine atoms, it is preferable to add an acid-accepting agent to the rubber component. By adding the acid-accepting agent to the rubber component, it is possible to prevent a chlorine gas generated when the rubber is vulcanized from remaining and other members from being contaminated.

As the acid-accepting agent, it is possible to use various substances acting as acid acceptors. As the acid-accepting agent, hydrotalcites or magsarat can be favorably used because they have preferable dispersibility. The hydrotalcite is especially favorable. By using the hydrotalcites or the magsarat in combination with a magnesium oxide or a potassium oxide, it is possible to obtain a high acid-accepting effect and securely prevent the other members from being contaminated.

The mixing amount of the acid-accepting agent for 100 parts by mass of the rubber component is set to not less than 1 nor more than 10 parts by mass and favorably not less than one nor more than five parts by mass. The mixing amount of the acid-accepting agent for 100 parts by mass of the rubber component is set to favorably not less than one part by mass to allow the acid-accepting agent to effectively display the effect of preventing inhibition of vulcanization and the other members from being contaminated. To prevent an increase of the hardness, the mixing amount of the acid-accepting agent for 100 parts by mass of the rubber component is set to favorably not more than 10 parts by mass.

When the vulcanized rubber composing the substrate 11 contains the ionic-conductive rubber, to impart a high electrostatic property to toner and improve the persistency of the electrostatic property, it is preferable to add a dielectric loss tangent-adjusting agent to the rubber component.

As the dielectric loss tangent-adjusting agent, weakly conductive carbon black or calcium carbonate treated with fatty acid is used. It is preferable to use the weakly conductive carbon black.

The weakly conductive carbon black is large in its particle diameter, has a low extent of development in its structure, and has a small degree of contribution to the conductivity. By adding the weakly conductive carbon black to the rubber component, a capacitor-like operation can be obtained owing to a polarizing action without increasing the electrical conductivity, and the electrostatic property can be controlled without damaging the uniformity of the electric resistance.

It is possible to efficiently obtain the above-described effect by using the weakly conductive carbon black whose primary particle diameter is not less than 80 nm and preferably not less than 100 nm. When the primary particle diameter is not more than 500 nm and preferably not more than 250 nm, it is possible to remarkably reduce the degree of the surface roughness. It is preferable that the weakly conductive carbon black is spherical or approximately spherical configurations because these configurations have a small surface area.

Various weakly conductive carbon blacks can be selected. For example, it is favorable to use carbon black produced by a furnace method or a thermal method which provide particles having large diameters. The furnace method is more favorable than the thermal method. SRF carbon, FT carbon, and MT carbon are preferable in terms of the classification of carbon. The carbon black for use in pigment may be used.

It is preferable to use not less than five parts by mass of the weakly conductive carbon black for 100 parts by mass of the rubber component so that the weakly conductive carbon black substantially displays the effect of reducing the dielectric loss tangent. It is preferable to use not more than 70 parts by mass of the weakly conductive carbon black for 100 parts by mass of the rubber component to prevent an increase of the hardness and other members which contact the member for the image-forming apparatus from being damaged and avoid the wear resistance from lowering. To obtain a small voltage fluctuation of the electric resistance of the roller with respect to an applied voltage, namely, to obtain so-called ionic-conductive property, the mixing amount of the weakly conductive carbon black for 100 parts by mass of the rubber component is set to favorably not more than 70 parts by mass. From the standpoint of the performance of mixing the weakly conductive carbon black with other components, the mixing amount of the weakly conductive carbon black for 100 parts by mass of the rubber component is set to more favorably 10 to 60 parts by mass and especially favorably 25 to 55 parts by mass.

The calcium carbonate treated with the fatty acid is more active than ordinary calcium carbonate and lubricant, because the fatty acid is present on the interface of the calcium carbonate. Thus it is possible to realize a high degree of dispersion of the calcium carbonate treated with the fatty acid easily and reliably. When the polarization action is accelerated by the treatment of the calcium carbonate with the fatty acid, there is an increase in the capacitor-like operation in the rubber owing to the above-described two actions. Thus the dielectric loss tangent can be efficiently reduced. It is preferable that the surfaces of particles of the calcium carbonate treated with fatty acid are entirely coated with the fatty acid such as stearic acid.

The mixing amount of the calcium carbonate treated with the fatty acid is not less than 30 parts by mass and favorably 40 to 70 parts by mass for 100 parts by mass of the rubber component. It is preferable that the mixing amount of the calcium carbonate treated with the fatty acid is not less than 30 parts by mass for 100 parts by mass of the rubber component so that the calcium carbonate treated with the fatty acid substantially displays the effect of reducing the dielectric loss tangent. To prevent a rise in the hardness and a fluctuation in the electric resistance, it is preferable that the mixing amount of the calcium carbonate treated with the fatty acid is not more than 80 parts by mass for 100 parts by mass of the rubber component.

In addition to the above-described components, the rubber may appropriately contain additives such as a plasticizer, a deterioration prevention agent, a filler, a scorch retarder, ultraviolet ray absorber, a lubricant, a pigment, an antistatic agent, a fire retarding agent, a neutralizing agent, a core-forming agent, a foaming agent, a foam prevention agent, and a crosslinking agent so long as the use thereof is not contradictory to the object of the present invention.

As the plasticizer, dibutyl phthalate (DBP), dioctyl phthalate (DOP), tricresyl phosphate, and wax are listed. It is preferable that the mixing amounts of these plasticizing components are not more than five parts by mass for 100 parts by mass of the rubber component to prevent bleeding from occurring and other members such as the photosensitive member from being contaminated when the roller is mounted on a printer and when the printer or the like is operated. In view of this purpose, it is most favorable to use polar wax.

As the deterioration retarder, various age resistors and antioxidants are used.

As the filler, it is possible to list powdery fillers such as titanium oxide, aluminum oxide (alumina), zinc oxide, silica, carbon, clay, talc, calcium carbonate, magnesium carbonate, and aluminum hydroxide. By adding the filler to the rubber component, it is possible to improve the mechanical strength and the like.

The addition amount of the filler for 100 parts by mass of the rubber component is set to favorably not more than 60 parts by mass and more favorably not more than 50 parts by mass. The weakly conductive carbon black also serves as the filler.

As the scorch retarder, N-cyclohexylchiophthalimide; phthalic anhydride, N-nitrosodiphenylamine, 2,4-diphenyl-4-methyl-1-pentene, and the like are listed. It is preferable to use the N-cyclohexylchiophthalimide. These scorch retarders can be used singly or by combining a plurality of these scorch retarders in combination. The addition amount of the scorch retarder for 100 parts by mass of the rubber component is set to favorably not less than 0.1 nor more than 5 parts by mass and more favorably not less than 0.1 parts by mass nor more than 1 part by weight.

The roller-shaped substrate 11 composed of the vulcanized rubber is produced by carrying out a normal method.

In detail, after components composing the substrate 11 are kneaded by using a mixing apparatus such as a kneader, a roller, a Banbury mixer or the like, the mixture of the components is preformed tubularly by using a rubber extruder. After the preform is vulcanized, the core 2 is inserted into the hollow portion of the preform and bonded thereto. After the preform is cut to a necessary size, the surface of the preform is abraded appropriately and roller-shaped.

An optimum vulcanizing time period should be set by using a vulcanization testing rheometer (for example, Curast meter). To prevent the roller from contaminating other members and decrease the degree of the compression set, it is preferable to set conditions in which a possible largest vulcanization amount is obtained. More specifically, the vulcanization temperature is set to favorably 100 to 220° C. and more favorably 120 to 180° C. The vulcanization time period is set to favorably 15 to 120 minutes and more favorably 30 to 90 minutes. When the substrate is composed of two or more layers, the substrate is produced in conformity to the above-described method. Thus the substrate can be produced by vulcanizing it in a plurality of layers with an extruding vulcanizing can or by continuous vulcanization.

It is preferable that the substrate 11 of the roller 1 shows the following properties.

The surface roughness Rz is in the range of 1˜10 μm. The difference between a surface roughness (Rza) of the substrate 11 having the surface roughness Rz before the film is formed on the surface thereof and a surface roughness (Rzb) of the substrate 11 after the film 12 is formed on the surface thereof is set to 2 μm˜0.3 μm.

It is preferable that the electric resistance value of the substrate 11 is 10³˜10¹⁰Ω.

The hardness of the durometer hardness test type A described in JIS K 6253 is favorably 20 to 90 degrees, more favorably 40 to 80 degrees, and most favorably 50 to 70 degrees. This is because the softer the substrate 11 is, the larger a nip is. Consequently there are advantages that transfer, electric charging, and development can be efficiently accomplished or mechanical damage to other members such as the photosensitive member can be decreased. On the other hand, when the hardness is lower than 20 degrees, the wear resistance is significantly inferior.

The developing roller is preferably used to feed the unmagnetic one-component toner to the photosensitive member. The developing method used in the image-forming mechanism of the electrophotographic apparatus is classified into a contact type and a noncontact type in terms of the relationship between the photosensitive member and the developing roller. The rubber member of the present invention can be utilized in both types. When the rubber member of the present invention is used as the developing roller, it is preferable that the developing roller substantially contacts the photosensitive member.

In addition to the developing roller, the roller 1 can be used as a charging roller for uniformly charging a photosensitive drum, a transfer roller for transferring a toner image from the photosensitive member to a transfer belt and paper, a toner supply roller for transporting toner, a cleaning roller for removing residual toner, and the like. Examples 1 through 8 and Comparison Examples 1, 2

After the components shown in table 1 were used at the rates shown therein and kneaded by using a Banbury mixer, the kneaded components were extruded by a rubber extruder to obtain a tube of each of the examples and the comparison examples having an outer diameter of φ22 mm and an inner diameter of φ9 mm to φ9.5 mm. Each tube was mounted on a shaft, for vulcanizing use, having a diameter of φ8 mm. After vulcanization was carried out in a vulcanizing can for one hour at 160° C., the tube was mounted on a core, having a diameter of φ10 mm, to which a conductive adhesive agent was applied. The tube and the shaft were bonded to each other in an oven at 160° C. After the ends of the tube were cut, traverse abrasion was carried out by using a cylindrical abrading machine. Thereafter the surface of the tube was abraded to a mirror-like surface finish. In this manner, a conductive roller, of each of the examples and the comparison examples, having a diameter of φ20 mm (tolerance: 0.05) were obtained.

TABLE 1

| | | Mixing amount |
|---|---|---|
| | | (part by mass) |
| Rubber component | Chloroprene rubber | 60 |
| | Epichlorohydrin copolymer | 40 |
| Other components | Weakly conductive carbon black | 40 |
| | Hydrotalcite | 5 |
| | Powdery sulfur | 0.5 |
| | Ethylene thiourea | 1.4 |

As the components shown in table 1, the following products were used:

### (a) Rubber Component

Chloroprene rubber: “Shoupuren WRT” produced by Showa Denko K.K. (SP value=19.19)
Epichlorohydrin copolymer: “Epion ON301” produced by DAISO CO., LTD.
EO(ethylene oxide)/EP(epichlorohydrin)/AGE(allyl glycidyl ether)=73 mol %/23 mol %/4 mol %)

### (b) Other Components

Weakly conductive carbon black: “Asahi #15” produced by Asahi carbon Co., Ltd.
Average primary particle diameter: 120 nm, Oil absorption amount: 29 ml/100 g, Amount of iodine adsorption: 14 mg/g
Conductive carbon black: “Denka black” produced by Denki Chemical Industry Co., Ltd.
Hydrotalcite (Acid-accepting agent): “DHT-4A-2” produced by Kyowa Chemical Industry Co., Ltd.
Powdery Sulfur (Vulcanizing Agent)
Ethylene thiourea (vulcanizing agent): “Axel 22-S” produced by Kawaguchi Chemical Industry Co., Ltd.

In the examples 1 through 8 and the comparison example 2, a film of titanium or aluminum was formed on the surface of the obtained conductive roller which was used as the substrate.

More specifically, a jig for rotating the conductive roller was formed and disposed inside an ion-plating device. With the roller being rotated, the film of titanium or aluminum was formed by ion plating. In this manner, the roller used as the member for the image-forming apparatus was obtained.

The following properties were measured on the roller of each of the examples and the comparison example. The results are shown in table 2 shown below.

TABLE 2

| | | | | | | | | | | Com- | Com- |
|---|---|---|---|---|---|---|---|---|---|---|---|
| | | Example | Example | Example | Example | Example | Example | Example | Example | parison | parison |
| | | 1 | 2 | 3 | 4 | 5 | 6 | 7 | 8 | example 1 | example 2 |
| Film | Material | Ti | Ti | Ti | Ti | Ti | Ti | Ti | Al | — | Al |
| | Thickness | 5 | 17 | 33 | 75 | 240 | 490 | 990 | 900 | — | 10000 |
| | (nm) | | | | | | | | | | |
| Hardness of roller | | 70 | 70 | 70 | 70 | 70 | 70 | 70 | 70 | 70 | 70 |
| Surface roughness (μm) | | 5.8 | 6.1 | 5.9 | 6.0 | 5.9 | 6.6 | 8.0 | 5.5 | 6.2 | 3.0 |
| Change in surface roughness (nm) | | 0.4 | 0.1 | 0.3 | 0.2 | 0.3 | 0.4 | 1.8 | 0.7 | — | 3.2 |
| | | ∘ | ∘ | ∘ | ∘ | ∘ | ∘ | Δ | ∘ | | x |
| Electric resistance | R₅₀ (logΩ) | 5.1 | 5.1 | ∘ | 5.1 | 5.1 | 5.1 | 5.1 | 5.0 | 6.2 | less than 3.0 |
| of roller | R₂₀₀ (logΩ) | 5.0 | 5.0 | 5.0 | 5.0 | 5.0 | 5.0 | 5.0 | 5.0 | 6.1 | less than 3.0 |
| Nonuniformity of | When 50 V | 1.1 | 1.3 | 1.2 | 1.2 | 1.2 | 1.2 | 1.2 | 1.1 | 1.9 | — |
| electric resistance | is applied | | | | | | | | | | |
| | When 200 V | 1.0 | 1.0 | 1.0 | 1.0 | 1.0 | 1.0 | 1.0 | 1.0 | 1.6 | — |
| | is applied | | | | | | | | | | |
| | Judgment | ∘ | ∘ | ∘ | ∘ | ∘ | ∘ | ∘ | ∘ | x | — |
| Print test | Toner trans- | 0.45 | 0.39 | 0.4 | 0.4 | 0.4 | 0.43 | 0.5 | 0.47 | 0.52 | 0.6 |
| | port amount | | | | | | | | | | |
| | Print density | 1.88 | 1.88 | 1.95 | 1.92 | 1.9 | 1.92 | 1.8 | 1.88 | 1.78 | 1.78 |
| | C2000/T2000 | 4.2 | 4.8 | 4.9 | 4.8 | 4.8 | 4.5 | 3.6 | 4.0 | 3.4 | 2.96 |
| | Evaluation | ∘ | ⊚ | ⊚ | ⊚ | ⊚ | ∘ | ∘ | ∘ | Δ | x |

A glass roller having the same configuration as that of the conductive roller which is the substrate was prepared. A part of the glass roller was masked with a permanent marker. The glass roller was put in the ion-plating device, together with the conductive roller which is the substrate to form a film by the ion plating.

Thereafter the permanent marker applied to the glass roller was wiped out with a solvent to form a portion where a film of titanium or aluminum was formed and a portion where a film was not formed and thus the surface of the glass was exposed. The length of a portion different in level was measured with a scanning probe microscope (SPM). An obtained value was equal to the thickness (mm) of the film.

### (2) Measurement of Hardness of Roller

In accordance with JIS K 6253, the hardness of the durometer hardness test type A was measured.

### (3) Measurement of Surface Roughness

In accordance with JIS B 0601 (1994), surface roughness was measured by a surface roughness measuring machine of contact type.

A surface roughness (Rzb) of the member of the comparison example 1 on which the metal film was not formed was set as the reference to observe a change in a surface roughness (Rza) of each of the members of the examples 1 through 8 and the comparison example 2 on which the metal film was formed. More specifically, a difference (Rzb−Rza) between the surface roughness (Rzb) before the film was formed and the surface roughness (Rza) after the film was formed was computed. Members having the difference not more than 1.0 μm was evaluated as ∘. Members having the difference in the range of 1.0 μm to 2.0 μm was evaluated as ␣. Members having the difference exceeding 2.0 μm was evaluated as ×.

### (4) Measurement of Electric Resistance of Roller

As shown in FIG. 6, a roller-shaped member 1, for an image-forming apparatus, through which a core 2 was inserted was mounted on an aluminum drum 13, with the member 1 in contact with the aluminum drum 13. A leading end of a conductor having an internal electric resistance of r (100Ω) connected to a positive side of a power source 14 was connected to one end surface of the aluminum drum 13. A leading end of a conductor connected to a negative side of the power source 14 was connected to one end surface, of the member 1, which was disposed opposite to the one end surface of the aluminum drum 13. In this manner, the electric resistance of member 1 was measured.

A voltage V applied to the internal electric resistance r of the conductor was detected. Supposing that a voltage applied to the apparatus is E, the electric resistance R of the roller is: R=r×E/(V−r). Because the term −r is regarded as being extremely small, R=r×E/V. A load F of 500 g was applied to both ends of the core 2. The voltage E of 50V or 200V was applied to the roller, while it was being rotated at 30 rpm. The detected voltage V was measured at 100 times during four seconds. R was computed by using the above equation. The measurement was conducted at a constant temperature of 23° C. and a constant relative humidity of 55%.

Log₁₀ R₅₀ of an electric resistance R₅₀Ω when an applied voltage was 50V and log₁₀ R₂₀₀ of an electric resistance R₂₀₀Ω when an applied voltage was 200V are described in table 1. In a condition in which the applied voltages were 50V, 200V, a measurable electric resistance was about 10⁴Ω. Thus the electric resistance of the member of the comparison example 2 which was unmeasurable was measured by applying a voltage of 1V at which electric resistances not less than 10²Ω can be measured. As a result, the electric resistance of the member of the comparison example 2 was less than 10³Ω. Thus the electric resistance thereof is described as “less than 3” in table 2.

In the case of voltages of 50V and 200V were applied, from a maximum value and a minimum value of 100 measured values, the ratio (maximum value/minimum value) was computed and described in table 2 as nonuniformity of electric resistance.

It is preferable that the nonuniformity of electric resistance is in the range of 1˜1.5. The nonuniformity of electric resistance was judged by marking members having the nonuniformity of electric resistance in the above-described range with ∘ and by marking members having the nonuniformity of electric resistance out of the above-described range with ×.

### (5) Measurement of Print Density

The roller-shaped member, for the image-forming apparatus, of each of the examples and the comparison examples was mounted on a laser printer (commercially available printer in which unmagnetic one-component toner was used. Recommended number of sheets which can be printed with toner: 7000 sheets) as a developing roller to measure a print density.

The measurement of the print density was substituted by the measurement of a transmission density as shown below. After 1% printing was performed on 2000 sheets of paper, a black solid image was printed on 2001th sheet of paper. The transmission density was measured by using a reflection transmission densitometer (densitometer “Teshikon RT120/light table LP20” produced by TECHKON Inc.) at given five points on each of the sheets of paper on which the black solid images was printed. The average of five measured transmission densities was set as the print density (as C2000).

The reason the transmission density was measured after printing was performed on 2000 sheets of paper is because normally a running operation finishes when printing is performed on about 2000 sheets of paper.

### (6) Measurement of Toner Transport Amount

After the print density was measured, a white solid image (blank) was printed on a 2002th sheet of paper. Thereafter a cartridge was removed from the laser printer to suck toner from above the developing roller mounted on the cartridge by using a charged amount-measuring machine of an absorption type (“Q/M METER Model 210HS-2” produced by Trek Inc.) so that the mass (mg) of the toner was measured. Based on the following equation, the toner transport amount (T2000) was computed from obtained values.

Toner transport amount (mg/cm²)=Mass (mg) of toner/Sucked area (cm²)

### (7) Relationship Between Print Density and Toner Transport Amount

To check the relationship between the print density and the toner transport amount, (print density/toner transport amount) was computed. The larger the value is, the higher the developing efficiency is. More specifically, members which caused the value to be not less than 4.5 were evaluated as □. Members which caused the value to fall in the range of 3.5 to 4.5 were evaluated as ⊚. Members which caused the value to fall in the range of 3.0 to 3.5 were evaluated as □. Members which caused the value to fall less than 3.0 were evaluated by ×.

It was estimated that in the member of the comparison example 2, a nonuniform image was generated, and toner leaked.

The metal films formed on the members of the examples had a thickness of 5 to 900 nm respectively and were favorable in that the surface roughness little changed as compared with the member of the comparison example 1 where the film was not formed. The change in the surface roughness of the members of the examples 1 through 6 was small and close to that before the films were formed, which indicates that the thickness of the film is more favorably 1˜490 nm. The change in the surface roughness of the examples 2 through 5 was smaller, which indicates that the thickness of the film is especially favorably 17˜240 nm.

The members of the examples 1 through 8 had a lower electric resistance and smaller nonuniformity of electric resistance than the member of the comparison example 1 where the film was not formed.

These results indicate that even a very thin film which coats the surface of the substrate without influencing the configuration of the surface of the substrate is capable of making the electric resistance low and the electric resistance uniform.

It could be confirmed that when the members of the examples are mounted on the image-forming apparatus, the print density with respect to the toner transport amount tends to be high and the developing efficiency can be improved.

It could be confirmed that when the thickness of the film is large like the member of the comparison example 2, the electric resistance is so low that it is difficult to use the member for the image-forming apparatus.

1-8. (canceled)

9. A member for an image-forming apparatus comprising a substrate consisting of a rubber or a resin; and a metal film, formed on a surface of said substrate, which consists of a metal, a metal oxide, a metal carbide, a metal nitride or a metal sulfide.

10. The member for an image-forming apparatus according to claim 9, wherein a rough surface or irregularities are formed on said surface of said substrate; and said metal film having a thickness not more than 1000 nm is formed on said surface of said substrate in a state in which a configuration of said surface of said substrate is maintained.

11. The member for an image-forming apparatus according to claim 9, wherein said metal film is a conductive film formed by ion-plating one or a plurality of kinds of metals selected from a group consisting of titanium, aluminum, nickel, copper, chromium, molybdenum, tungsten, zinc, tin, indium, iron, silver, gold, and magnesium and alloys of these metals.

12. The member for an image-forming apparatus according to claim 10, wherein said metal film is a conductive film formed by ion-plating one or a plurality of kinds of metals selected from a group consisting of titanium, aluminum, nickel, copper, chromium, molybdenum, tungsten, zinc, tin, indium, iron, silver, gold, and magnesium and alloys of these metals.

13. The member for an image-forming apparatus according to claim 9, wherein a surface roughness Rz of said substrate is 1 μm to 10 μm; a difference between said surface roughness Rz of said substrate and said surface roughness Rz of said film formed on said surface of said substrate to coat said surface thereof is not more than 2 μm; and a thickness of said film is 5 nm to 990 nm.

14. The member for an image-forming apparatus according to claim 9, wherein said substrate is formed by molding crosslinked rubber, thermoplastic resin or thermoplastic elastomer; and said substrate is conductive and has an electric resistance value of 10³˜10¹⁰Ω.

15. The member for an image-forming apparatus according to claim 14, which charges a toner or a photosensitive member.

16. The member for an image-forming apparatus according to claim 9, which is roller-shaped, sheet-shaped, belt-shaped or blade-shaped.

17. The member for an image-forming apparatus according to claim 16, which consists of a developing roller.
